(19) United States
(12) Patent Application Publication
(10) Pub. No.: US 2004/0199429 A1
(43) Pub. Date: Oct. 7, 2004

(54) Schemes for rating cruises

(76) Inventor: Daniel Kwoh, Pasadena, CA (US)

Correspondence Address: CHRISTIE, PARKER & HALE, LLP, P.O. BOX 7068, PASADENA, CA, 91109-7068, US

(21) Appl. No.: 10/757,637

(22) Filed: Jan. 13, 2004

Related U.S. Application Data
(60) Provisional application No. 60/439,693, filed on Jan. 13, 2003.
(60) Provisional application No. 60/441,901, filed on Jan. 21, 2003.
(60) Provisional application No. 60/500,815, filed on Sep. 4, 2003.

(51) Int. Cl. G06F 17/60

(52) U.S. Cl. 705/26

(57) ABSTRACT

A method for rating a cruise and a method for rating a cruise price. The method for rating a cruise involves obtaining pricing data, identifying correlations between the pricing data and one or more price affecting factors, and calculating a cruise rating. The method for rating a cruise price involves obtaining historic pricing data, calculating expected price of a cruise, and comparing the expected price of the cruise to the price of the cruise.

### CROSS-REFERENCE TO RELATED APPLICATION

This application claims priority to and the benefit of U.S. Provisional Application No. 60/439,693, filed on Jan. 13, 2003; U.S. Provisional Application No. 60/441,901, filed on Jan. 21, 2003; and U.S. Provisional Application No. 60/500,815, filed on Sep. 4, 2003 at the United States Patent and Trademark Office the entire disclosures of which are incorporated fully herein by reference.

### BACKGROUND

Consumers often consider ratings of various products before making purchase decisions. There are multiple consumer reports which publish ratings for a wide range of products, from automobiles to vacuum cleaners to cameras to hotels and etc. There is also a variety of rating systems. For example, hotels are often rated on a five-star system and restaurants are often given letter ratings based on cleanliness. Whatever the system or the rating, the goal is to provide a simple way for consumers to make informed purchasing decisions.

Some ratings are more useful than others. Several factors may effect usefulness of a rating, for example, whether it is objective, whether it is timely, or whether it is comprised of certain attributes. Many of the presently-known ratings are based on a system which gathers input from a group of critics who are guided by a predefined set of criteria. Such a process can be tedious and long, and, as a result, the rating may not be timely. In addition, the results of such a process are highly objective.

A critic-based rating system is currently used in the cruise ship industry. The traditional method of rating cruise ships involves sending one or more critics on board the ship under evaluation (SUE), who then grade the ship based on a set of criteria. The grades are then used to calculate the rating of the SUE. Such a system intrinsically contains various disadvantages. For example, it may lack in objectivity. Various subjective factors of what is deemed “good” or “bad” by some critics are reflected in the rating. The ratings may also not be available on a timely basis, since the critics must be given time to evaluate specific cruises, to submit their evaluations, and for the evaluations to be processed into a rating. Furthermore, automatic timely updates of such ratings may not be feasible.

Also, consumers often shop for discounts and cruise lines often offer particular cruise ships at a discount. For example, very few cruises are ever sold at the list price. The amounts discounted from list prices do not indicate how good the deals are. Whether or not a deals is “good” depends on the discount of the actual true worth of the cruise. Most of the deals advertised by the cruise lines, such as the ones advertised in news papers, magazines, or online, are items identified by travel agents based on their experience and guesses and might not always reflect the best deals.

The present invention discloses a scheme for rating cruise ships which is intended to address some or all of these problems.

### SUMMARY OF THE INVENTION

According to one embodiment of the present invention, a method for rating a cruise is provided. Pricing data for a cruise is obtained. One or more price affecting factors are identified. Correlation coefficients for the pricing factors are calculated, and a cruise rating or a pricing index is calculated or determined. Another embodiment of the invention provides a method for rating a cruise wherein pricing data is obtained, price per diem of the cruise is determined, and a price index is calculated based on the price per diem. Another embodiment of the invention provides a method for rating cruise ships. Pricing data is obtained and a daily price for each ship is calculated using at least one price affecting factor. Daily price is compared with the pricing data, and, if comparison shows sufficient accuracy or correlation, a price index of a cruise or a cruise rating is calculated.

Another embodiment of the invention provides a method foe evaluating a cruise price. Pricing data is obtained and an expected price of the cruise is calculated. The cruise price is compared with the expected price.

### BRIEF DESCRIPTION OF THE DRAWINGS

Features and advantages of the present invention will be better understood by reference to the following detailed description when considered in conjunction with the accompanying drawings herein:

FIG. 1 shows a block diagram of a typical Internet environment used in at least one embodiment of the present invention;

FIG. 2 is a block diagram of a system for rating cruises in accordance with an embodiment of the present invention;

FIG. 3 is a flowchart showing a process for determining a cruise rating according to an embodiment of the present invention;

FIG. 4A-4E show sample charts of seasonal price changes utilized in one embodiment of the invention;

FIG. 5A-5C show sample displays of cruise ratings and/or price indexes utilized in one embodiment of the invention;

FIG. 6A-6E shows samples of displaying ratings of discounted cruise prices utilized in one embodiment of the invention; and

FIG. 7 shows an example of the use of comparison of cruise prices and average cruise prices utilized in one embodiment of the invention.

### DETAILED DESCRIPTION

An examplary embodiment is directed to an automated method which can be performed by a computer for rating cruises as well as to a computer system for implementing it. The embodiment is directed to a method for objectively analyzing prices of a ship over a period of time, factoring in one or more variables which are known to effect the price, and computing a price-based index for that ship. The cruise may also receive a rating, based on the price-based index, which will reflect the value of that cruise.

Cruise prices vary based on a number of factors. Some of the known factors observed in the past include the season of travel, price, proximity to holidays, school breaks (when a significant number of schools is not in session), region of travel, destination, length of cruise, route, embarkation and disembarkation ports, ports of call, age of the ship, etc. In addition, discounts are often offered.

The complicated interaction of these and other factors is reflected in the market prices for cruises. That is, the efficiency of the market, the experience of the cruise lines, and the competition in the industry provide that cruise prices inherently include all of the factors which affect the price of the cruise. Due to the highly efficient market in internet based commerce, the price is a good indicator of the quality of the product and as a result, provides a good basis for a rating.

The price that the cruise has been able to consistently command over a period of time reflects the consuming public's judgment of the quality or worth of that cruise. Thus, the price of the cruise should be directly proportional to its quality and may be used as a basis of a rating. In one embodiment the average price of a cruise over an extended period of time for a particular cruise ship, or ships of a particular cruise line company, such as a year for example, forms the basis of the price index, rating, or goodness of that cruise.

In another embodiment, ratings of cruise ships from the same cruise line company can be used to calculate a rating for that cruise line company. For example, an average rating may be determined. As a result, shoppers will be able to compare various cruise line companies, in addition to various ships. For example, shoppers may be able to compare overall ratings and determine that Carnival Cruises is rater higher or lower than Carnival Cruises.

Once the price index of a cruise ship or a cruise line is calculated, it can be displayed to a user to enable the user to make informed purchasing decisions as well as to allow the user to compare various cruise prices.

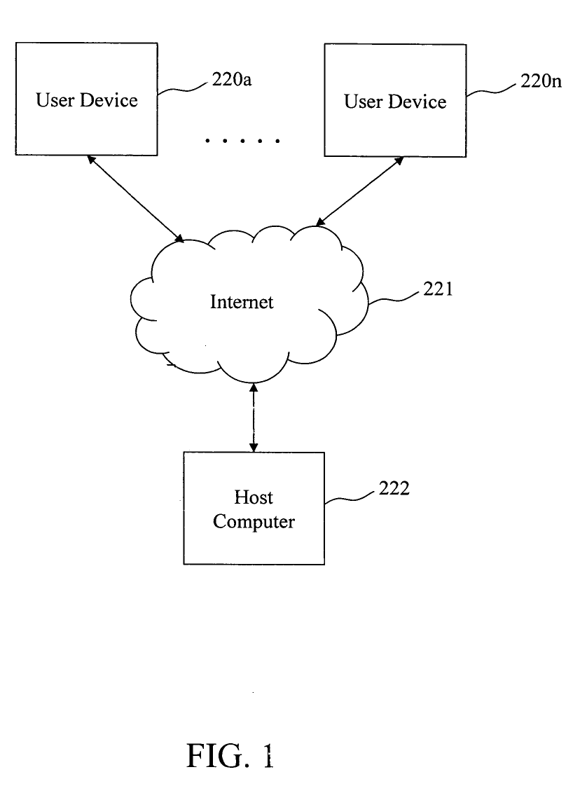

FIG. 1 shows a block diagram of a typical Internet environment used in at least one embodiment of the present invention. The system functions between a user device 220 (one of a number of user devices 220 a-n) and a host computer 222. The user device 220 is a device for displaying information obtained from the Internet 221, such as a monitor, a computer, a TV with web-browsing capabilities, or any other device for displaying with web-browsing capability.

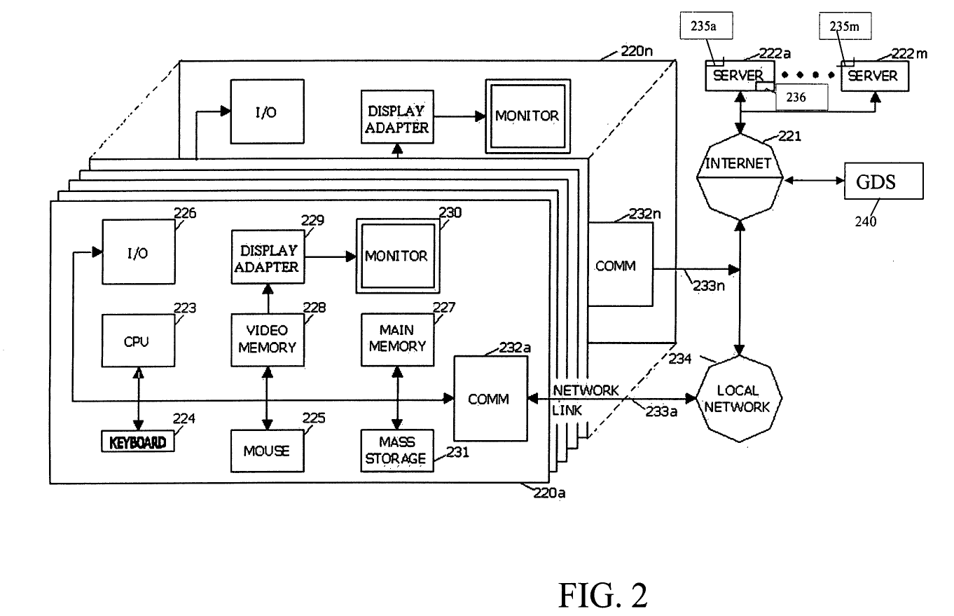

FIG. 2 shows a block diagram of a typical Internet client/server environment used by the users and servers in one embodiment of the present invention. User devices 220a-220n used by the users are connected to the Internet 221 through communication links 233a-233n. Optionally, a local network 234 may serve as the connection between some of the user devices 220a-220n, such as the user device 220a and the Internet 221. Servers 222a-222m are also connected to the Internet 221 through respective communication links. Servers 222a-222m include information and databases accessible by the user devices 220a-220n. In one embodiment of the present invention, databases for storing travel product information reside on at least one of the servers 222a-222m and are accessible by users using one or more of the user devices 220a-220n to obtain travel product information.

In an alternative embodiment of the present invention, the travel product databases are stored on a Global Distribution System 240. Travel product information, including current travel prices and availability, is gathered from travel product providers and stored on the Global Distribution System 240. The Global Distribution System 240 is accessible by at least one of the servers 222a-222m through the Internet.

In yet another alternative embodiment, the travel product databases are stored on computers of the individual travel product providers. Each of the travel product databases stored on computers of the individual travel product providers contains travel product information, including current prices and availability. The databases stored on computers of the individual travel service providers are accessible by at least one of the servers 222a-222m through the Internet.

In one embodiment of the present invention, each of the user devices 220a-220n typically includes a central processing unit (CPU) 223 for processing and managing data; and a keyboard 224 and a mouse 225 for inputting data. A main memory 227 such as a Random Access Memory (RAM), a video memory 228 for storing image data, and a mass storage device 231 such as a hard disk for storing data and programs are also included in a typical user device. Video data from the video memory 228 is displayed on a Display screen 230 by a display adapter 229 under the control of the CPU 223. A communication device 232, such as a modem, provides access to the Internet 221. Optionally, one or more of user devices 220a-220n may be connected to a local network 234. An Input/Output (I/O) device 226 reads data from various data sources and outputs data to various data destinations.

Servers (hosts) 222a-222m are also computers and typically have architecture similar to the architecture of user devices 220a-220n. Generally, servers differ from the user devices in that servers can handle multiple telecommunications connections at one time. Usually, servers have more storage and memory capabilities, and higher speed processors. Some server (host) systems may actually be several computers linked together, with each handling incoming web page requests. In one embodiment, each server 222a-222m has a storage medium 235a-235m, such as a hard disk, a CD drive, or a DVD for loading computer software.

When software such as the software responsible for executing the processes of the present invention is loaded on the server 222a, an off-the-shelf web management software or load balancing software may distribute the different modules of the software to different servers 222a-222m. A server may utilize an operating system such as DOS, Microsoft Windows, or Linux. The server may use off the shelf, or open source software to generate and serve web pages. In an embodiment, the server uses Apache server software to generate and serve web pages. The page generating software generates web pages that have, for example, hypertext markup language (HTML) and JavaScript components. Additionally, the server may be protected from unauthorized access by the use of a firewall, such as one produced by Checkpoint.

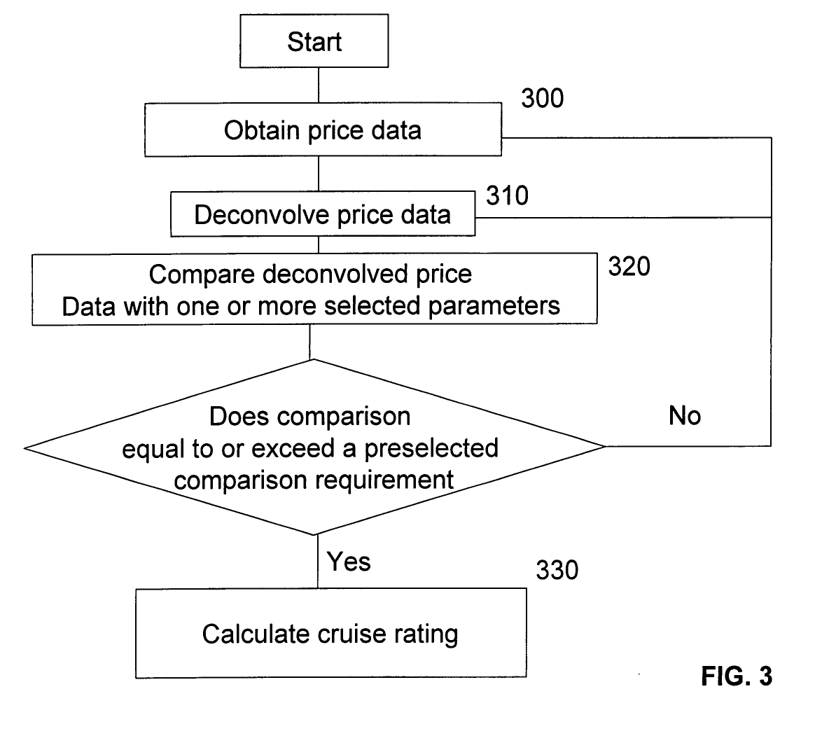

Therefore, in one embodiment, the computer program responsible for executing the present invention resides on one or more servers. Databases to carry out the processes of FIG. 3 may be created, maintained and edited in many different types of database software including Access, FoxPro, and Oracle. In one embodiment of the present invention the database software is made by Oracle.

An exemplary web site location 235 is shown on server 222a in FIG. 2. The web site 235 is the user interface for accessing the database described below. The web site 236 has an address that is used by the users to access server 222a (in this example) and the web site location on the server 222a. The computer software for executing the processes of the present invention may also reside on the web site 236.

FIG. 3 shows a flowchart for the method of obtaining a cruise rating or price index. Cruise rating and price index may, but do not have to be, the same. First, price data for a cruise is obtained, box 300. This data contains a list of prices for a particular cruise over a set period of time, such as one year for example. The price data obtained may be limited to one or more particular cabin types, or may contain prices for all cabins or various options on a particular ship. In one embodiment, obtaining the price data information may be accomplished by the host computer 222. In another embodiment, obtaining the price data information may be accomplished by the user device 220 through the Internet 221. Obtaining price data may involve accessing a remote server or a database where such information resides and downloading the pertinent data. Obtaining price data may also involve accessing a web-site, such as a web directory of cruise prices or the web site of a particular cruise, to download pricing information. Current prices for cruises may also be downloaded or collected on a periodic basis and stored in a database at the host computer 222. Price data may also be obtained from commercial databases through direct dial phone lines or through their website. This database may then be accessed to obtain price data.

Second, the price data is analyzed and deconvolved, box 310. Correlations between various price affecting factors and the obtained price data may be identified.

Cruise prices vary based on a number of factors. Correlations between many factors and cruise prices may be identified based on historic prices of cruises. A regression analysis or formula may be created and applied to predict future values of cruise prices. Correlation coefficients can be used to determine the validity and/or accuracy of the regression analysis or formula.

The correlations can be taken down a number of levels, and can be as involved or detailed as the user desires or as is feasible. Linear as well as non-linear regressions may be then be utilized between various price-affecting factors and price. The coefficient of each factor can be considered as the weighting factor. These weighting factors, or correlation coefficients, are determined by a set of data for some predetermined period of time, for example, one year. When new data becomes available as time goes on, the coefficients can be updated to fit the new data.

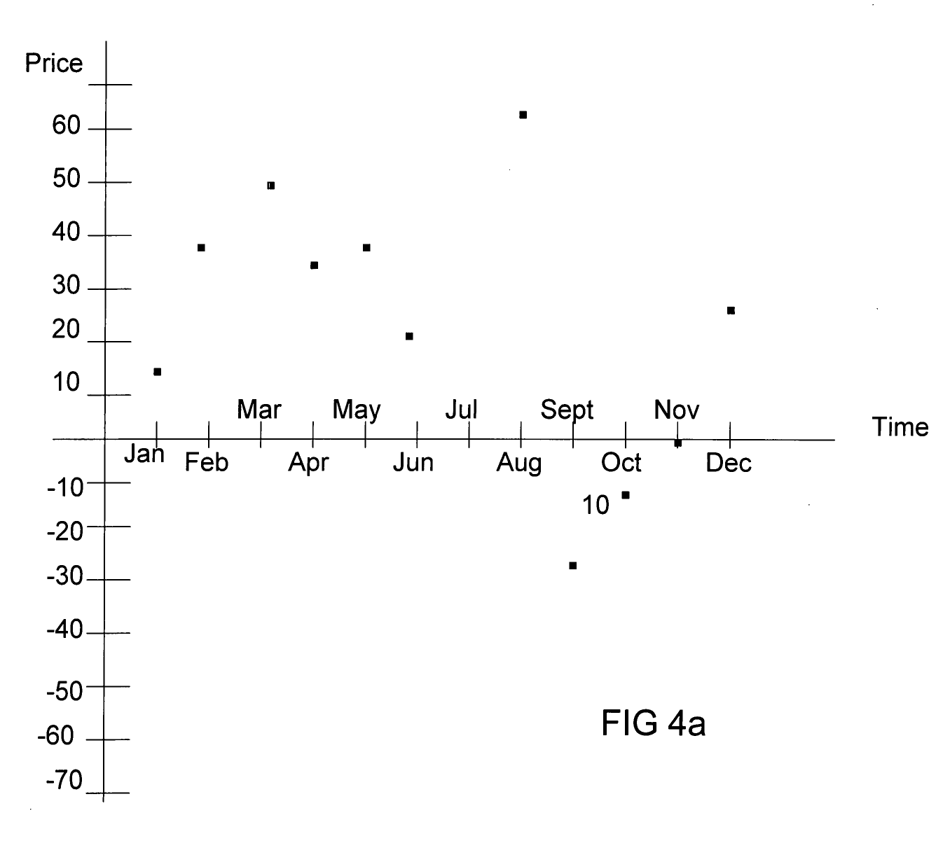

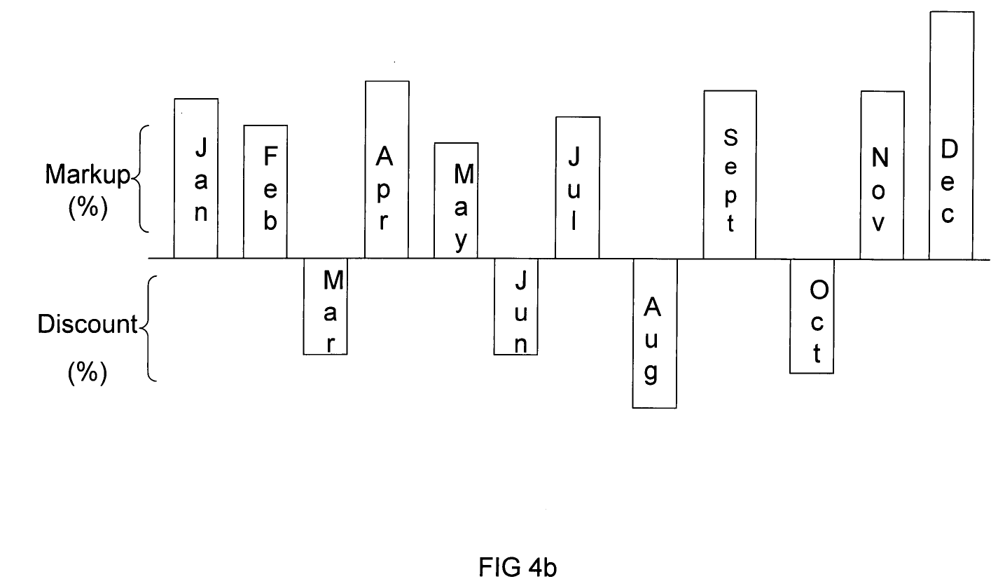

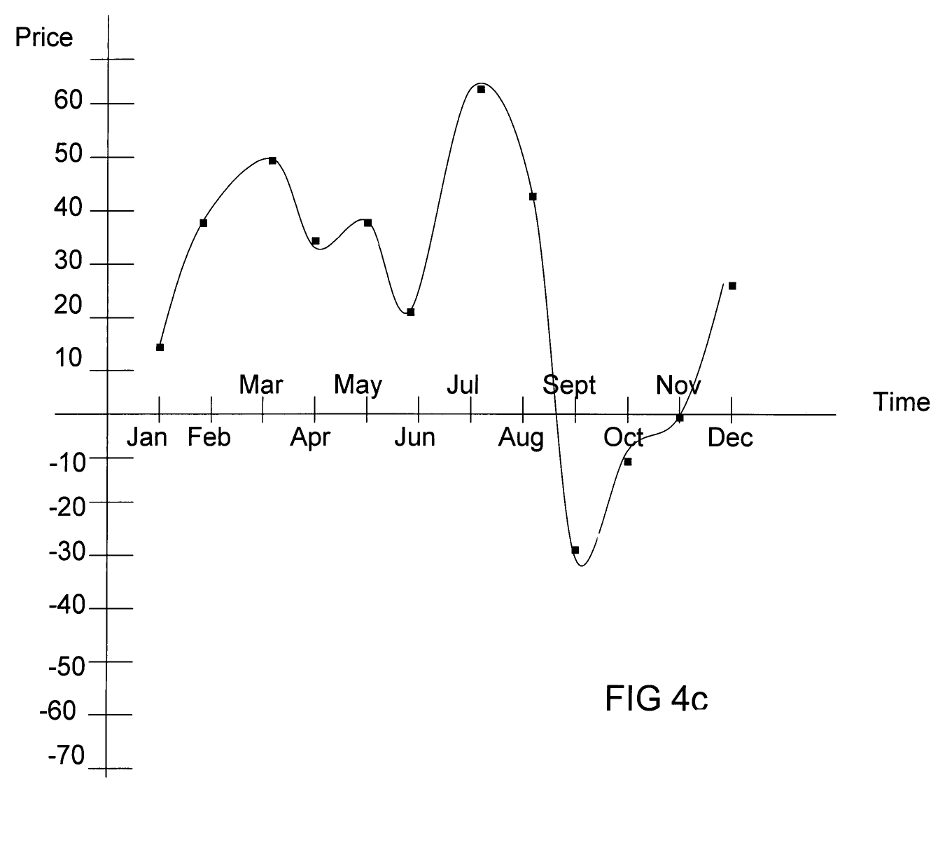

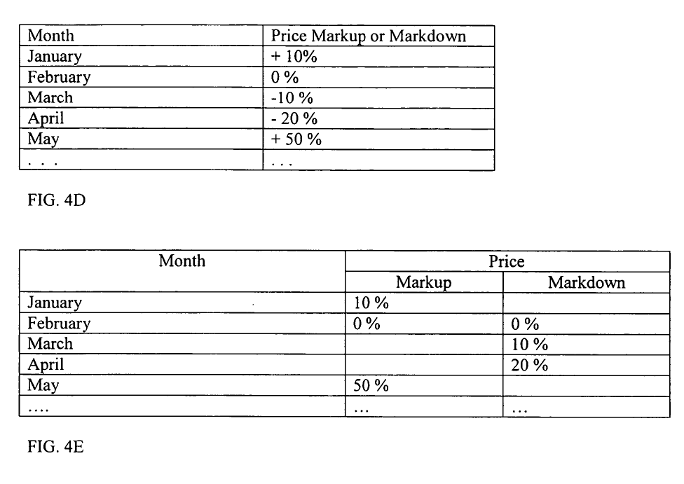

For example, FIGS. 4a-4e show a sample chart of cruise prices as they relate to seasons utilized in one embodiment of the invention. In one embodiment, months of the year are displayed along a first axis 40 and the ordinary discount or markup of the cruise price is displayed along a second axis 41. Negative data points on the second axis 41 represent a discount in prices. That is, FIG. 4a shows that cruise prices are discounted by 10% in the month of September. Positive data points represent a markup in cruise prices. For example, during holidays and spring breaks cruise prices may carry a premium of over 100%. In FIG. 4a, for example, it can be seen that the cruise prices in the month of July are higher than the prices in the month of October by 75%. The correlation of prices to times of the year may be displayed in various formats such as set of data points (FIG. 4a), a block graph (FIG. 4b), a linear regression (FIG. 4c), a table format (FIG. 4d, 4e), or any other format convenient for displaying information.

Time can be further broken down to finer elements, for example weeks or days, instead of months. Specific weeks, “spring break” week for example, or specific days (Christmas for example), or even months or seasons (“summer”, “January”), may affect cruise prices differently. Prices for cruises on Christmas day may be offered at a particular markup. Prices for some cruises during the week of “spring break” (a week in spring when a significant number of universities is not in session) may also be at a markup. While the week before or after the “spring break” the cruise may actually be discounted.

Some cruises are affected by school breaks differently. This may depend on the cruise line. For example, cruise lines geared to children, such as the Disney cruise line, or young adults, such as Carnival Cruises, may be in higher demand and more expensive during school breaks. While cruises where children and young adults do not comprise a significant portion of the travelers, such as the Royal Caribbean, might not experience the same demand during school breaks. The region of travel may also influence how school break effects the price of the cruise. For example, demand for a cruise to Europe is not likely to increase during a school break (assuming that Europe is not a very popular destination for students on a break). However, prices for cruises to destinations popular with vacationing students, such as the Caribbean or Mexico, are likely to be much higher during school breaks.

Some cruises are also affected by seasons differently. For example, a cruise to Alaska during winter might not be as popular due to Alaska's cold winter weather as a cruise to Hawaii or the Caribbean. Thus, the winter season would effect prices of these cruises differently.

These and other fluctuations can also effect different room categories in different ways. For example, the cheapest room categories may be in more demand when students are traveling. Rooms with a view may be in more demand, and thus more expensive, on a longer cruises or cruise to a particularly picturesque destination.

Regions of travel and ports of embarkation may also effect cruise prices. For example a cruise to Caribbean may be more expensive than a cruise to Mexico, or a Caribbean cruise from San Juan may be cheaper than a Caribbean cruise embarking in Florida. Price in a particular region of travel may further relate to the season or length of travel. Ports of call may also effect the price. For example, a cruise to Hawaii making a stop at a number of islands may be more expensive than a cruise to Hawaii stopping in Honolulu only.

The age of a cruise ship, as well as the name of the cruise line may also effect the cruise price. Newer ships may have better amenities or more entertainment attractions (such as a rock-climbing wall or an indoor skating ring), which would command a higher price.

Historic price data can be analyzed to identify numerous correlations and/or regressions between price affecting factors and cruise prices. These factors can include any of the ones discussed above or any other number of factors that have historically shown to influence cruise prices.

Referring back to FIG. 3, after the price data is deconvolved to obtain the price for a particular cruise, box 310, the deconvolved data is then compared to select parameters to ensure accuracy or consistency, box 320. For example, the deconvolved data for a particular ship may be compared to historic prices for that ship over the preceding 12 months. The deconvolved data may be deemed consistent if the comparison yields some preset amount of overlap in prices or if it does not deviate more than x % from the historic prices. Alternatively, a correlation coefficient can be calculated between the historic prices and the deconvolved data. A minimum correlation coefficient can then be set to determine accuracy or consistency. As another example, the deconvolved data may be compared to select dates, regions, cruises, cruise lengths, or itineraries to ensure accuracy or consistency. If the deconvolved price data does not meet consistency requirements, the obtained price is deconvolved again to obtain a more accurate result, box 310, or new price data may need to be obtained, box 300. If the deconvolved price data exceeds a predetermined consistency requirement, it is then further used in establishing a cruise rating, box 330.

In one embodiment, the cruise rating is equal to the price index of a cruise and is equal to the average price per diem of that cruise. That is, if Cruise A has been able to consistently demand an average price of $120 per passenger per day, Cruise A's price index will be 120. In this case, if a consumer compares two cruises—Cruise A, with a price index of 120, and Cruise B, with a price index of 100—where both cruises are being offered for a price of $110, it will be apparent that Cruise A is offered at a discount, while Cruise B's price is offered at a 10% mark-up.

In another embodiment, the average range of cruise prices for various ships is normalized to a range, such as range of 1 through 5. In this embodiment, the price index system rating is similar to the 5-star system rating. For example, if the range of cruise prices is $100 to $500 and this range is normalized to a range of 1 through 5, a price index of $200 will correspond to cruise rating of 2. A cruise with price index of $400 will correspond to cruise rating of 4.

In yet another embodiment, the average cruise price is set to 1 and the deviation from the average is converted to decimals. In this embodiment, the price index of a ship will be a direct multiplier for purposes of price comparison.

In another embodiment, the price index of a cruise is set to a scale, such as a number, a letter, or a star scale. The scale values may range from 1, A, or one star to any higher value (such as from 1 to 10 or from A to F).

In one embodiment, the daily price of a cruise is determined by dividing the price of the lowest available cabin by the number of days in a cruise. In other embodiments, average prices as well as other definitions can be used.

Once cruise rating or price index of a cruise is calculated, the results may be displayed to the user in a variety of ways. The cruise rating or price index can be displayed on monitor 230 or on the screen or monitor of any other user device 220.

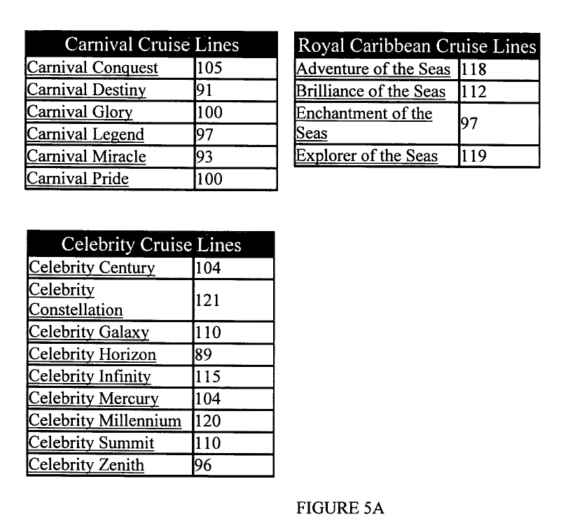

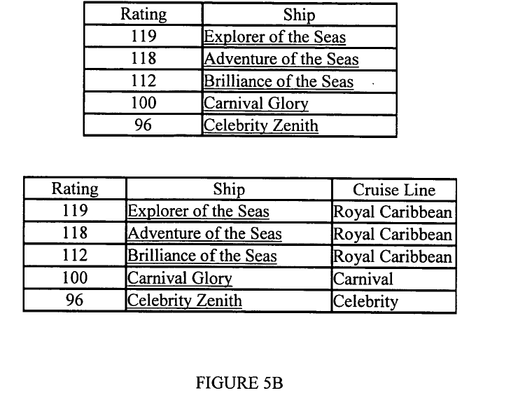

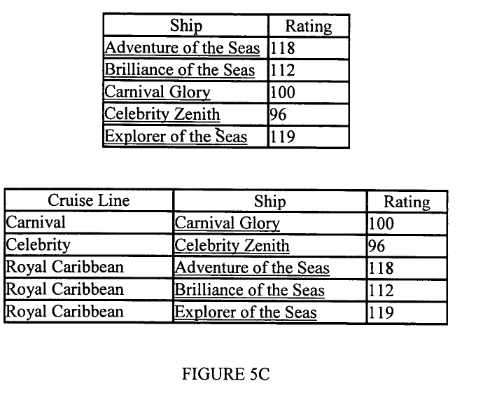

FIGS. 5a-5c show various presentations of cruise rating data to a user. FIG. 5a shows an exemplary display of cruise ratings to the user. One or more tables 510 are displayed wherein each table contains ratings for cruise ships from one cruise line 520. One column of each table 510 shows ship names and another shows the corresponding cruise rating or price index. This display may show various cruise lines, with various ships comprising the cruise line. It allows a quick way to establish the best and worst quality ships within each cruise line, as well as the overall comparison between the various cruise lines. FIG. 5b shows a display of cruise ratings in the order of the rating, which can be highest to lowest or vise versa. FIG. 5c shows a display ordered by cruise ship's name or by cruise line's names. However, any other method of conveniently displaying information, such as cruise ratings or price indexes, may be used in this invention. For example, such information may be displayed alongside cruise's current listings, the web pages showing information for a cruise, in special comparative reviews, or in any other manner useful for a user.

Another embodiment of the invention utilizes historical pricing data to determine the fair market value (FMV) of a cruise. For example the price index or price rating of the cruise may be used to determine the FMV. FMV can be further broken down by ship, by sailing, by cabin categories, etc.

Once the FMV of a cruise is determined, it can be used to analyze the advertised prices for various cruises. Cruise lines often advertise particular prices as “deals” (a discounted price), however the advertised “deals” might not always be as good as advertised or reflect true discounts. Thus, in one embodiment of the invention, the FMV is used to determine and display the true worth of the advertised discount.

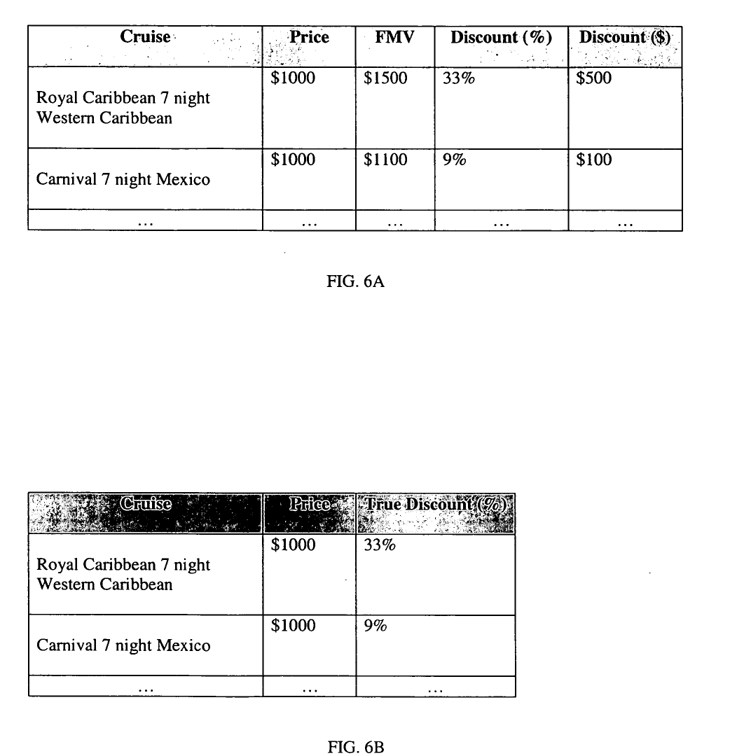

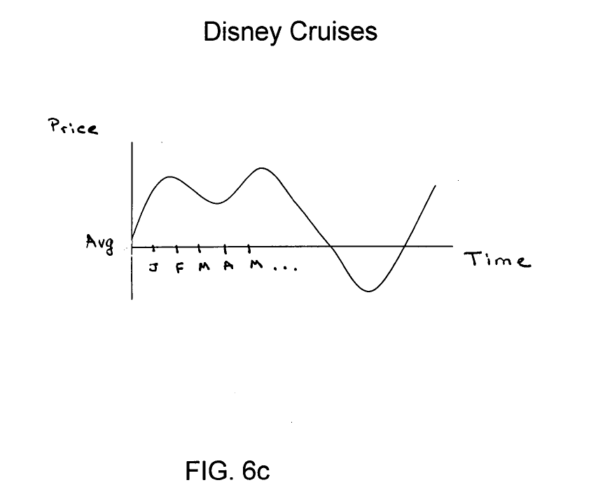

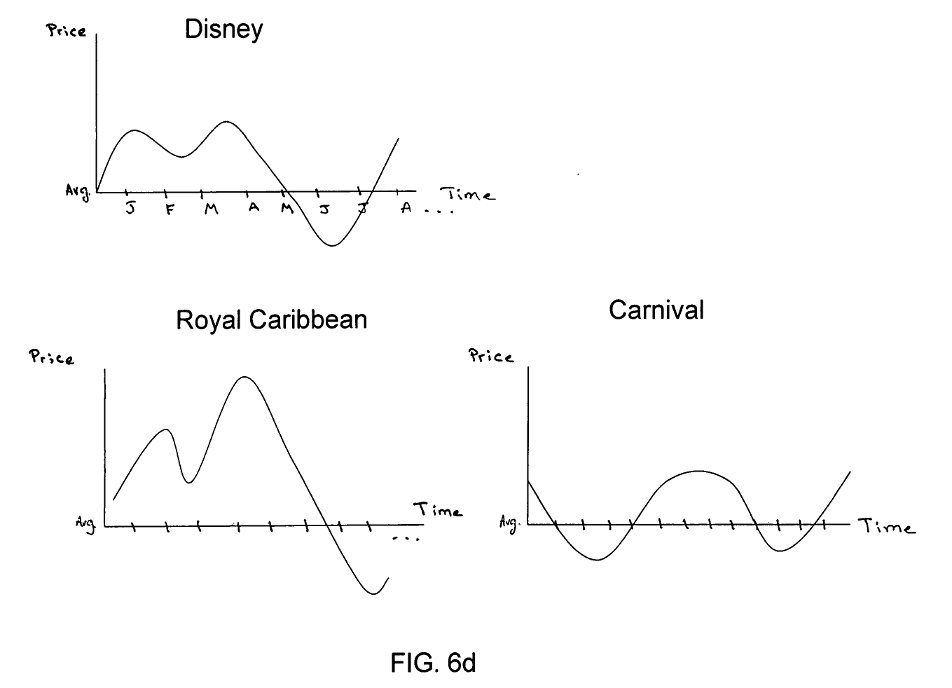

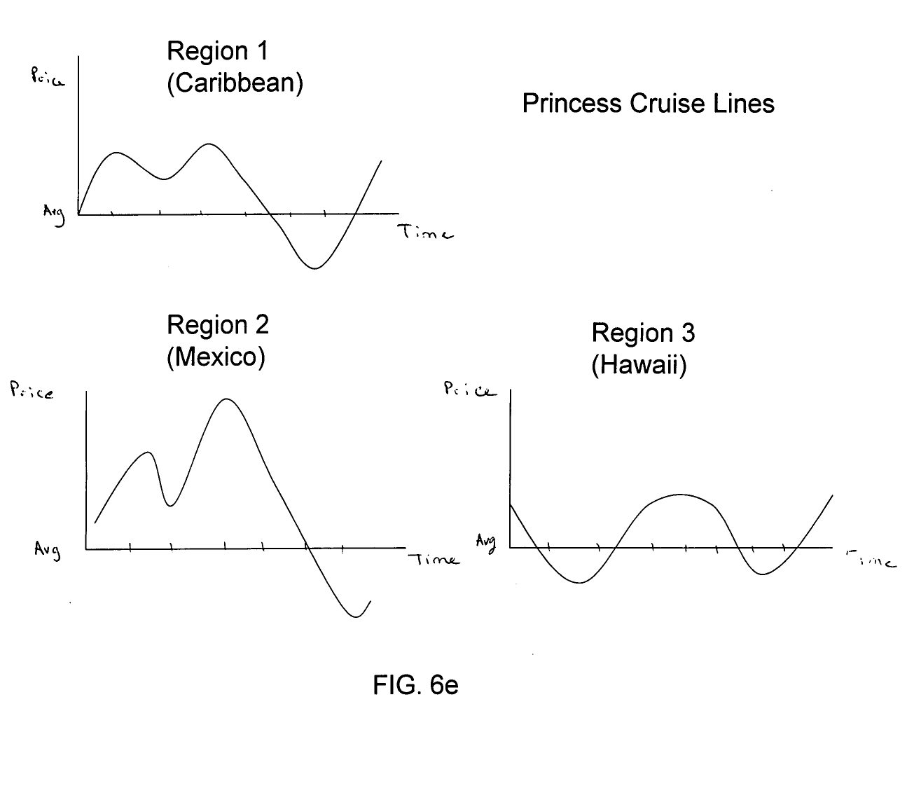

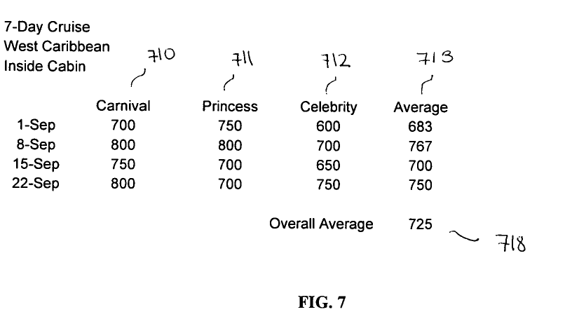

Another embodiment of the invention utilizes the historic data of cruise prices to determine the FMV value of a particular cruise. An estimated true worth of a cruise (also referred to as FMV) is calculated. The advertised discounted price of a cruise is then compared to the true worth of the cruise. The results of the comparison are then displayed to a consumer in a variety of ways. FIG. 6 shows various examples of such displays (graphs, charts, tables, lists, etc.).

For example, a seven-day cruise in the West Caribbean can be advertised at $1000 as a 50% discount from the list price of $2000. The true worth of the cruise is estimated and the true discount can be calculated. For example, the true worth is estimated to be $1500. In that case, the true discount would be only 33%, not the 50% as advertised. Customers often look for the best deal with the best discount. This information may enable them to identify such deals. Deals may also be listed by the amount of true discount so that the customer can pick the true best deals easily. In one embodiment, the true discounts can be presented visually in different colors. For example, the most outstanding discounts may be represented in Red, and good discounts can be represented in Green. Multiple-tier system of color coding can be used to denote true discounts.

In addition, this process can be applied to all discounts and advertised deals so that true savings can be estimated. Such data may be provided to newspapers, magazines, or on-line advertisers for publishing. A complete list may also be published on a website so that consumers can look up particular cruises or cruise lines to shop for value an determine actual savings.

In another embodiment, price of a particular cruise is compared with the FMV of that cruise and an index. Ratio of the price to FMV is calculated. If the ratio is larger than 1 or 100%, the price is higher than the FMV. If the ratio is less than 1 or 100%, the price is lower than the FMV. When this FMV is used together with the rated ship index, an informed decision can be made. A simplified example of the rated ship index can be derived from dividing the average price of the ship or the cruise line by the average price of all of the cruises.

In one embodiment, the FMV is calculated by collecting all published, discounted prices of the same and/or similar sailings and calculating the average price of such sailings. For example, to obtain a FMV for an inside cabin, 7 days, West Caribbean, cruise in September 2003, all the published prices for this class cabin with the same length of cruise in the same location from Carnival, Princess, Celebrity, and other cruise lines are collected for the month of September. The FMV is then calculated based on the collected prices. In yet another embodiment, FMV is the average of these collected prices. The time period over which comparative prices are collected can be chosen to be similar to the period of the sailing in questions. For example, if the customer is inquiring about a sailing in September, the average of all sailings from all cruise lines within September can be used. In another embodiment, a longer or shorter period can be used. In another embodiment, only sailings within that particular week can be chosen.

Different FMVs can be obtained for different cabin classes of a cruise. For example, one FMV can be calculated for the outside cabins, and a different FMV can be calculated for the inside cabins. A different FMV can be calculated for each cabin class.

FIG. 7 shows an example of this embodiment. Prices for an inside cabin for a 7-day, West Caribbean cruise are collected from three cruise lines. The prices for each week are listed as shown in columns 710, 711, 712. The average of each week is calculated as shown in the average column, 713, and the average for all the prices in September is also calculated as the overall average, 718. The average values of column 713 represent the FMVs of for the respective dates of sailings. For example, the FMV of a cruise sailing for the first week of September is $683. The FMV for the second week of September is $767.

Using the example of FIG. 7, a simplified rated ship index for Carnival cruise lines would be approximately 1.05. The average price of the Carnival line in September is $765. The average price for all cruise lines, the overall average, 718, is $725. The savings can be calculated by dividing the average price of Carnival by the Carnival's rated ship index (765/1.05=726) and comparing the results with the average overall price 718. This example shows a saving of $1 or about 1% for the September prices on Carnival.

In another embodiment, comparing the price of a sailing on September 1 on Carnival, priced at $700, column 710, divided by the ship's rating index of about 1.05, to the FMV of such sail, $767, yields a ratio of 0.976. This means that the price of Carnival is lower than the FMV and the cruise is offered at a discount. The ratio can also be presented as percent saving. That is, in this example, the Carnival cruise of September 8 is offered at a saving of 2.4%.

In yet another embodiment, the overall average of the month, 718, can be used as the FMV. Using the example of FIG. 7, the FMV of a sail in September would be 725. Thus a cruise with a price of $700 will denote a savings of 4%.

Different averages can be used as the FMV. The choice of which average is used as the FMV may depend on the purpose of the comparison and may be chosen on a case-by-case basis or specified by a user.

The preceding description has been presented with reference to examplary embodiments of the invention. Workers skilled in the art and technology to which this invention pertains will appreciate that alterations and changes in the described structure may be practiced without meaningfully departing from the principle, spirit, and scope of this invention. Accordingly, the foregoing description should not be read as pertaining only to the precise system and method described and illustrated in the accompanying drawings, but rather should be read consistent with and as support for the following claims, which are to have their fullest and fairest scope.

What is claimed is:

1 A method for rating a cruise based on pricing data for the cruise for a predetermined period of time comprising:
identifying one or more price affecting factors;
calculating a one or more correlation coefficient for each of the one or more price affecting factors; and
calculating a cruise rating based on the pricing data, the one or more price affecting factors, and the one or more correlation coefficients.

2. The method of claim 1, wherein the at least one price affecting factor is comprised of at least one of price, season, cruise itinerary, cruise length, at least one port of call, geographic region, port of embarkation, port of disembarkation, date of sail, proximity to a holiday, proximity to a school break, and ship's age.

3. The method of claim 1, wherein the predetermined period of time is at least one year.

4. The method of claim 1, further comprising:
after calculating the price index based on the pricing data and the identified correlation, comparing the price index for each of the one or more cruise ships with the pricing data over a predetermined period of time;
if comparison does not exceed a predetermined value, identifying one or more additional correlation between the pricing data and at least one price affecting factor; and
calculating a new price index based on the pricing data and the identified one or more additional correlation.

5. The method of claim 1, further comprising:
after calculating the price index based on the pricing data and the identified correlation, comparing the price index for each of the one or more cruise ships with the pricing data over a predetermined period of time;
if comparison does not exceed a predetermined value, obtaining new pricing data for the cruise for a predetermined period of time;
identifying one or more correlation between the new pricing data and at least one price affecting factor; and
calculating a new price index based on the new pricing data and the identified correlation.

6. The method of claim 1, further comprising:
determining an average price index for one or more cruise ships of a particular cruise line; and
calculating a price index of the particular cruise line based on the average price index.

7. A method for rating a cruise based on pricing data for the cruise for a predetermined period of time comprising:
determining price per diem of the cruise; and
calculating a price index based on the price per diem of the cruise.

8. The method of claim 7, wherein the price index is equal to the price per diem.

9. The method of claim 7, wherein the price index is directly proportional to the price per diem.

10. A method for rating a cruise ship based on prices for one or more cruise ships over a predetermined period of time comprising:
calculating a daily price for each of the one or more cruise ships using at least one price affecting factor;
comparing the daily price for each of the one or more cruise ships with a pricing data for that ship over a predetermined period of time; and
if comparison exceeds a predetermined value, calculating a price index of each cruise ship based on the daily price for each one of the one or more cruises.

11. The method of claim 10, further comprising:
determining an average price of all daily prices for each of the one or more cruise ships; and
assigning a cruise rating for each one of the one or more cruise ships based on the average price.

12. The method of claim 10, further comprising:
calculating a range of daily prices of the one or more cruise ships; and
determining a cruise rating for the one or more cruise ships based on comparison of the daily price of the one or more cruise ships with the range of daily prices of the one or more cruise ships.

13. The method of claim 10 wherein the predetermined period of time is at least one year.

14. The method of claim 10 wherein the predetermined value is a set value of a correlation coefficient.

15. The method of claim 10 wherein the predetermined value is a set percentage.

16. A method for evaluating a cruise price being charged by a vendor based on pricing data for a one or more cruises for a predetermined period of time comprising:
creating a regression formula based on the pricing data, where the regression formula is a function of at least one price affecting factor;
calculating an expected price of a specific cruise based on the value of at least one price affecting factor of the specific cruise and the regression formula; and
comparing the cruise price being with the expected price.

17. The method of claim 16 further comprising the step of displaying the comparison between the cruise price and the expected price in a medium.

18. The method of claim of 17, wherein the medium is at least one of an electronic medium, a print medium, a sound medium, and a paper medium.

19. The method of claim 16, wherein the step of calculating an expected price of the cruise based on the pricing data and the identified correlation comprises:
calculating a price index based on the pricing data and the identified correlation; and
calculating the expected price of the cruise based on the price index.

20. The method of claim 16, wherein the at least one price affecting factor is comprised of at least one of price, season, cruise itinerary, cruise length, at least one port of call, geographic region, port of embarkation, port of disembarkation, date of sail, proximity to a holiday, proximity to a school break, and ship's age.

21. The method of claim 16, wherein the predetermined period of time is at least one year.

22. The method of claim 16, wherein the step of calculating an expected price of the cruise comprises:
calculating a price index based on the pricing data and the identified correlation;
comparing the price index with the pricing data for a second predetermined period of time;
if comparison does not exceed a predetermined value, identifying one or more additional correlation between the pricing data and the at least one price affecting factor,
calculating a new price index based on the pricing data and the identified one or more correlation, and
calculating the expected price of the cruise based on the new price index.

23. The method of claim 16 wherein the step of calculating an expected price of the cruise comprises:
calculating a price index based on the pricing data and the identified correlation,
comparing the price index with the pricing data for a second predetermined period of time,
if comparison does not exceed a predetermined value, obtaining new pricing data for the cruise for a predetermined period of time,
identifying one or more correlation between the new pricing data and at least one price affecting factor,
calculating a new price index based on the new pricing data and the identified correlation, and
calculating the expected price of the cruise based on the new price index.
